(19) United States
(12) Patent Application Publication
(10) Pub. No.: US 2024/0400357 A1
(43) Pub. Date: Dec. 5, 2024

(54) INJURY RISK MITIGATING RAISED FLOOR TILE SEPARATING DEVICE

(71) Applicant: International Business Machines Corporation, Armonk, NY (US)

(72) Inventors: Eric MILCZEWSKI, Port Ewen, NY (US); Phillip Alan LAWRENCE, Castleton, NY (US); Shane D. BRYANT, Albany, NY (US)

(21) Appl. No.: 18/325,693

(22) Filed: May 30, 2023

(51) Int. Cl. B66F 3/00

(52) U.S. Cl. CPC B66F 3/005; E04F 15/02405

(57) ABSTRACT

An example raised floor tile separating apparatus includes a frame, a pedal, and a pivot arm. The pivot arm has a first end coupled to the pedal and a second end coupled to a tile attachment tool. Another example raised floor tile separating apparatus includes a bottom member, a ratchet, a pedal having an inclination, a pulley, and a cable having a first end coupled to the ratchet and a second end coupled to a tile attachment tool. The cable extends from the first end to the second end through the pulley.

### BACKGROUND

The present disclosure relates to a tile separating device, and more specifically, to a raised floor tile separating device. Many facilities install elevated structural floors to enable utility routing and ease of access below the elevated walking surface. The area below the elevated structural floor may allow electrical and mechanical facilities to run beneath the floor and may be accessed to carry out various facility functions, such as maintenance, cleaning, and repair functions. An elevated structural floor is generally comprised of multiple metal tiles and is often referred to as a raised metal floor (RMF). The floor tiles may be perforated or non-perforated. To access the area below the elevated structural floor, one of the floor tiles has to be dislodged in order to create an entry point. However, dislodging a floor tile from the elevated structural floor is physically demanding and can impose a heavy burden on a person's back and limbs, leading to injury and other physical discomfort.

### SUMMARY

One embodiment described herein is a raised floor tile separating apparatus. The raised floor tile separating apparatus includes a frame having a bottom member, a first side member disposed on the bottom member, and a second side member disposed on the bottom member. The first side member is parallel to the second side member. The raised floor tile separating apparatus also includes a pedal disposed between the first side member and the second side member. The raised floor tile separating apparatus includes a pivot arm coupled to and disposed between the first side member and the second side member A first end of the pivot arm is coupled to the pedal and a second end of the pivot arm is coupled to a tile attachment tool.

Another embodiment described herein is a raised floor tile separating apparatus. The raised floor tile separating apparatus includes a bottom member, a ratched disposed above the bottom member, a pedal at an inclination with respect to the bottom member, a pulley coupled to the bottom member, and a cable having at least a first end coupled to the ratchet and a second end coupled to a tile attachment tool. The cable extends from the first end to the second end through the pulley.

Another embodiment described herein is a system. The system includes an elevated floor surface including multiple floor tiles. The system also includes an access area disposed beneath the elevated floor surface. The system further includes a raised floor tile separating apparatus. The raised floor tile separating apparatus is disposed on a first floor tile of the multiple floor tiles and has a tile attachment tool attached to an adjacent second floor tile of the multiple floor tiles.

### BRIEF DESCRIPTION OF THE DRAWINGS

FIG. 1 illustrates an example environment with a raised floor and a raised floor tile separating device, according to one embodiment.

FIGS. 2A-2C illustrate different views of an example raised floor tile separating device, according to one embodiment.

FIGS. 3A-3F illustrate different views of an example attachment tool for a raised floor tile separating device, according to one embodiment.

FIGS. 4A-4B illustrate different views of another example attachment tool for a raised floor tile separating device, according to one embodiment.

FIGS. 5A-5G illustrate an example scenario for operating a raised floor tile separating device, according to one embodiment.

FIGS. 6A-6C illustrate different views of another example raised floor tile separating device, according to one embodiment.

FIGS. 7A-7C illustrate another example scenario for operating a raised floor tile separating device, according to one embodiment.

### DETAILED DESCRIPTION

Conventional methods for separating floor tiles from an elevated floor surface often expose a user to risk of injury via back pain, herniated disks, pinch points, and other physical discomfort. Such conventional methods, for example, often involve a user engaging a floor tile with a tool (e.g., hex key, screwdrivers, suction cup, or other tool) and using physical force to dislodge the floor tile from the elevated floor surface. In many instances, however, the separation force that is needed to dislodge the floor tile can exceed a reasonable person's capability, which can expose the user to injury and physical discomfort as well as inhibit the tile from being dislodged at all. In situations where the user is unable to dislodge the tile, the user may be forced to search for an alternative tile, increasing the amount of time that it takes to gain access to the space beneath the floor surface.

To address this, embodiments described herein provide a floor tile separating device that is configured to dislodge or separate a floor tile from an elevated floor surface, while reducing injury risk to a user. For example, the floor tile separating device described herein can generate a scalable lifting force to ensure that the desired tile can be separated from the elevated floor surface, eliminating the need for the user to search for alternate tiles. The floor tile separating device can improve ergonomic safety by allowing a user to remain in a comfortable position while using the device, thus reducing the strain injury risk associated with the conventional method of the user using their back and legs to pull the floor tile. Additionally, the floor tile separating device described herein can be fully operated by a single user (as opposed to multiple users), is portable, fully assembled, easily stored, and cleanroom compatible. In certain embodiments, the floor tile separating device has attachments that allow it to engage with perforated tiles and non-perforated tiles.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

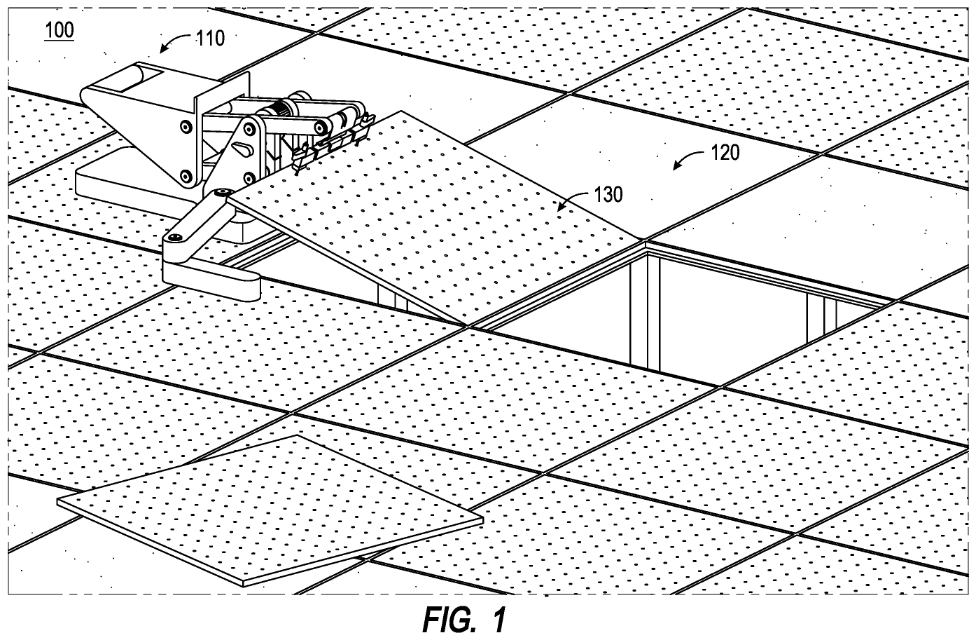

FIG. 1 illustrates an example environment with a raised floor 100 and example raised floor tile separating device 110, according to one embodiment. A raised floor is an elevated surface that includes one or more perforated tiles, one or more non-perforated tiles, or a combination thereof. Here, the raised floor 100 includes multiple perforated tiles 130 and multiple non-perforated tiles 120. In certain embodiments, a user can use the raised floor tile separating device 110 to dislodge or separate a floor tile from an elevated floor surface, such as the raised floor 100. As shown in FIG. 1, for example, the raised floor tile separating device 110 is placed on a floor tile that is adjacent to the target floor tile 130. As described in greater detail herein, the raised floor tile separating device 110 is in the form of a foot pedal. For example, when the user steps and presses down on the raised floor tile separating device 110, the directional force applied to the pedal of the raised floor tile separating device 110 is transferred and amplified as a lifting force to the floor tile 130. This lifting force dislodges the floor tile 130 from the raised floor in a safe and controlled manner relative to conventional methods.

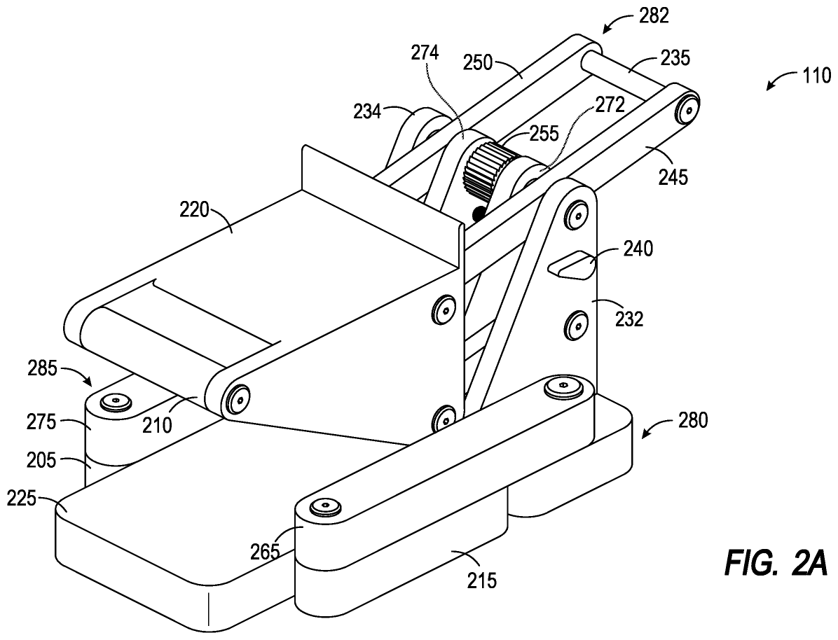

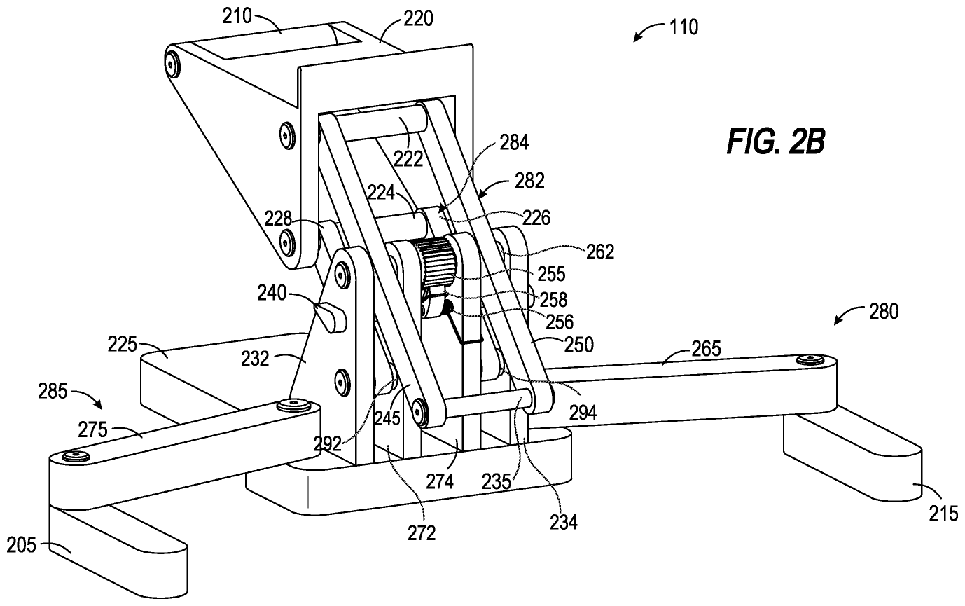

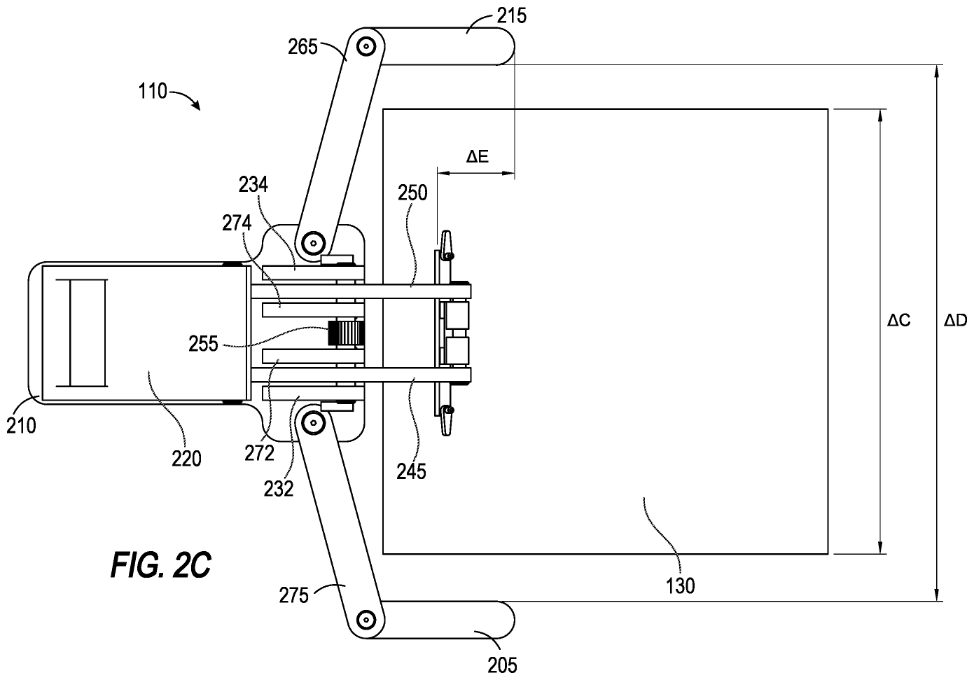

FIGS. 2A-2C illustrate different views of an example raised floor tile separating device 110, according to one embodiment. In particular, FIG. 2A is a perspective view of the raised floor tile separating device 110, FIG. 2B is another perspective view of the raised floor tile separating device 110, and FIG. 2C is a top view of the raised floor tile separating device 110. As shown, the raised floor tile separating device 110 includes a frame, which is comprised of a base 225, a side member 232, a side member 272, a side member 234, and a side member 274. Each side member 232, 272, 234, and 274 is disposed on a surface of the base 225.

The raised floor tile separating device 110 also includes two matching side arms 280 and 285. The side arm 280 includes a member 265 and a member 215. The side arm 285 includes a member 275 and a member 205. The side arms 280 and 285 can be adjusted to allow for easy storage and transportation throughout an environment. For example, as shown in FIG. 2A, the raised floor tile separating device 110 may have a compact form factor when the member 265 and the member 215 of the side arm 280 are folded in, and the member 275 and the member 205 of the side arm 285 are folded in. Similarly, as shown in FIG. 2B and FIG. 2C, when the raised floor tile separating device 110 is deployed, the member 265 and the member 215 of the side arm 280 can be extended, and the member 275 and the member 205 of the side arm 285 can be extended, such that the member 215 is parallel to one side of the floor tile 130 and the member 205 is parallel to another side of the floor tile 130. As shown in FIG. 2C, when the raised floor tile separating device 110 is deployed around a floor tile 130, the distance between the side member 215 and the side member 205 is D inches, where D is greater than C (e.g., the length/width of the floor tile 130).

Additionally, in certain embodiments, the side arms 280 and 285 can be used as anchors to prevent the raised floor tile separating device 110 from sliding or moving as the floor tile 130 is being dislodged from the elevated floor surface. Additionally or alternatively, in certain embodiments, the base 225 can be anchored to the floor tile underneath the base 225 to prevent the raised floor tile separating device 110 from sliding or moving as the floor tile 130 is being dislodged from the elevated floor surface. Additionally or alternatively, in certain embodiments, the bottom surface of the base 225 may include a non-slip resistant surface to prevent the raised floor tile separating device 110 from sliding or moving as the floor tile 130 is being dislodged from the elevated floor surface.

The raised floor tile separating device 110 further includes a pivot arm 282 and a pivot arm 284. The pivot arm 282 includes a member 245, a member 250, a connector 222 (e.g., rod, pin, bar, etc.), and a connector 235 (e.g., rod, pin, bar, etc.). The member 245 and the member 250 are coupled to each other via the connector 222 and the connector 235. As described below, in certain embodiments, the connector 235 is used for attaching an attachment tool, which can be used to engage a floor tile. The pivot arm 284 includes a member 226, a member 228, a connector 224 (e.g., rod, pin, bar, etc.), a connector 292 (e.g., rod, pin, bar, etc.), and a connector 294 (e.g., rod, pin, bar, etc.). The member 228 is coupled to the member 226 via the connector 224. The member 228 is also coupled to the side member 232 and the side member 272 via the connector 292. The member 226 is also coupled to the side member 274 and the side member 234 via the connector 294.

The pivot arm 284 is coupled to a pedal 220 (of the raised floor tile separating device 110) at one end of the pivot arm 284 (via connector 224) and is coupled to the side members 232 and 272 (via connector 292) and to side members 274 and 234 (via connector 294) at another end of the pivot arm 284. The pivot arm 282 is coupled to the pedal 220 at one end of the pivot arm 282 (via connector 222). The pivot arm 282 is also coupled to the side members 232, 272, 274, and 234 via the connector 262.

The raised floor tile separating device 110 also includes a ratchet 255 (also referred to as a ratchet wheel) disposed between the side members 272 and 274 via the connector 262. For example, a first end of the connector 262 is attached to the side member 232 and a second end of the connector 262 is attached to the side member 234. The connector 262 extends from the side member 232, through the side member 272, through the ratchet 255, and through the side member 274 to the side member 234.

The raised floor tile separating device 110 also includes a pawl 258 disposed between the side members 272 and 274. In certain embodiments, the pawl 258 is used to keep the ratchet 255 fixed or set in a particular position. For example, as the ratchet 255 rotates (e.g., when pressure is applied to the pedal 220), the pawl 258 may engage different notches (or teeth) of the ratchet 255. When pressure is not applied to the pedal 220, the spring 256 may keep the pawl 258 engaged in a particular notch of the ratchet 255. The raised floor tile separating device 110 includes a release mechanism 240, which can be used to disengage the pawl 258 from the ratchet 255 and reset the pedal 220 to a default position.

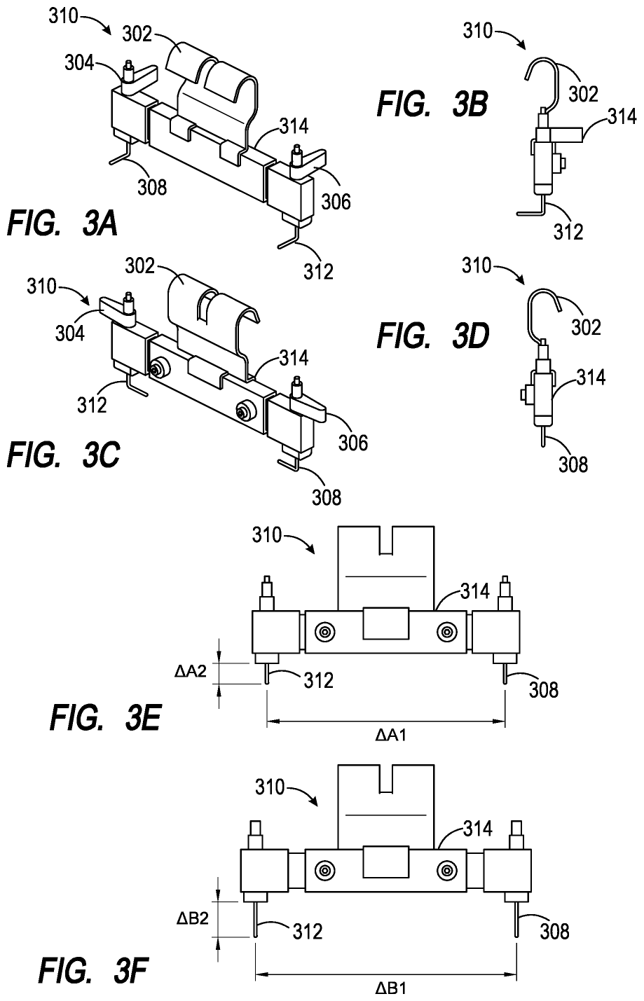

As noted, in certain embodiments, the raised floor tile separating device described herein can be connected to different types of attachment tools for interacting with a floor tile. FIGS. 3A-3F illustrate different views of an example attachment tool 310, which can be coupled to a raised floor tile separating device, according to one embodiment. In one embodiment, the attachment tool 310 is a hook attachment tool that is used to attach to a perforated floor tile, such as floor tile 130. The attachment tool 310 has a body 314, an attachment member 302 disposed on the body 314, a hook 308, a hook 312, a lever 304 for controlling hook 308, and a lever 306 for controlling hook 312. The attachment tool 310 may be coupled to a raised floor tile separating device via the attachment member 302. For example, the attachment member 302 may be attached to the connector 235 of the raised floor tile separating device 110.

The hooks 308 and 312 may be inserted into different holes of a perforated tile (e.g., floor tile 130) in a certain orientation (e.g., as shown in FIGS. 3A and 3B). After the hooks 308 and 312 are inserted into the perforated tile, the orientation of the hooks 308 and 312 can be adjusted (via levers 304 and 306) to keep the attachment tool 310 engaged with the perforated floor tile (e.g., as shown in FIGS. 3C and 3D). In certain embodiments, the portions of the hooks 308 and 312 that extend through the body 314 to the levers 304 and 306 may be threaded, and one or more nuts may be used to keep the hooks 308 and 312 secured when lifting a floor tile. In certain embodiments, the hook attachment tool 310 is adjustable. In such embodiments, the distance between the hooks 308 and 312 can be adjusted (e.g., from A1 in FIG. 3E to B1 in FIG. 3F, or vice versa) to match the distance between holes of a perforated floor tile, the height of the hooks 308 and 312 can be adjusted (e.g., from A2 in FIG. 3E to B2 in FIG. 3F, or vice versa) to correspond to the thickness of a perforated floor tile, or a combination thereof.

In certain embodiments, each attachment tool 310 may have a different configuration (e.g., different distance between hooks, different heights of the hooks) for interacting with a particular type of perforated floor tile. For example, a first hook attachment tool may have the configuration of the attachment tool 310 illustrated in FIG. 3E and a second hook attachment tool may have the configuration of the attachment tool 310 illustrated in FIG. 3F.

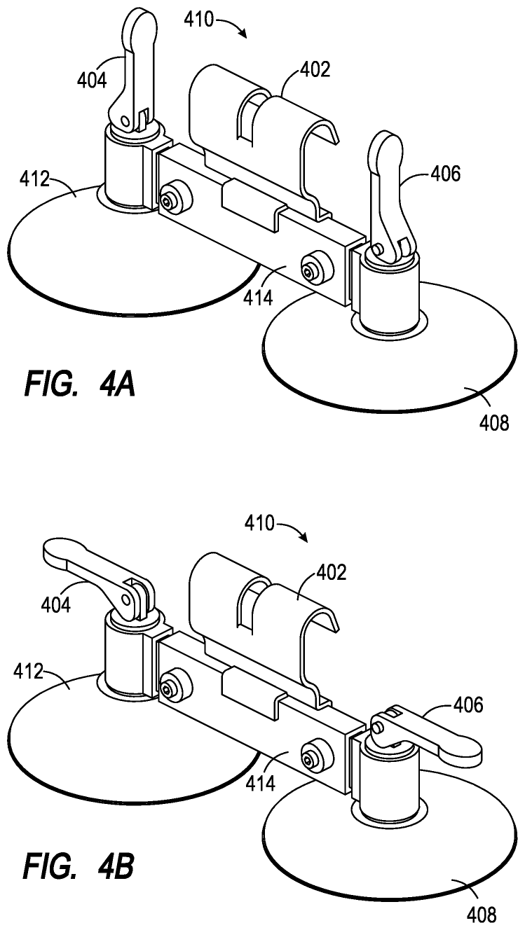

FIGS. 4A-4B illustrate different views of another example attachment tool 410, which can be coupled to a raised floor tile separating device, according to one embodiment. In one embodiment, the attachment tool 410 is a suction cup attachment tool that is used to attach to a non-perforated floor tile, such as floor tile 120. The attachment tool 410 has a body 414, an attachment member 402 disposed on the body 414, a suction cup 412, a suction cup 408, a lever 404 for controlling the suction cup 412, and a lever 406 for controlling the suction cup 408. The attachment tool 410 may be coupled to a raised floor tile separating device via the attachment member 402. For example, the attachment member 402 may be attached to the connector 235 of the raised floor tile separating device 110. In certain embodiments, after the suction cups 412 and 408 are applied to a non-perforated floor tile, the levers 404 and 406 can be adjusted used to keep the attachment tool 410 engaged with the non-perforated floor tile (e.g., as shown in FIG. 4B).

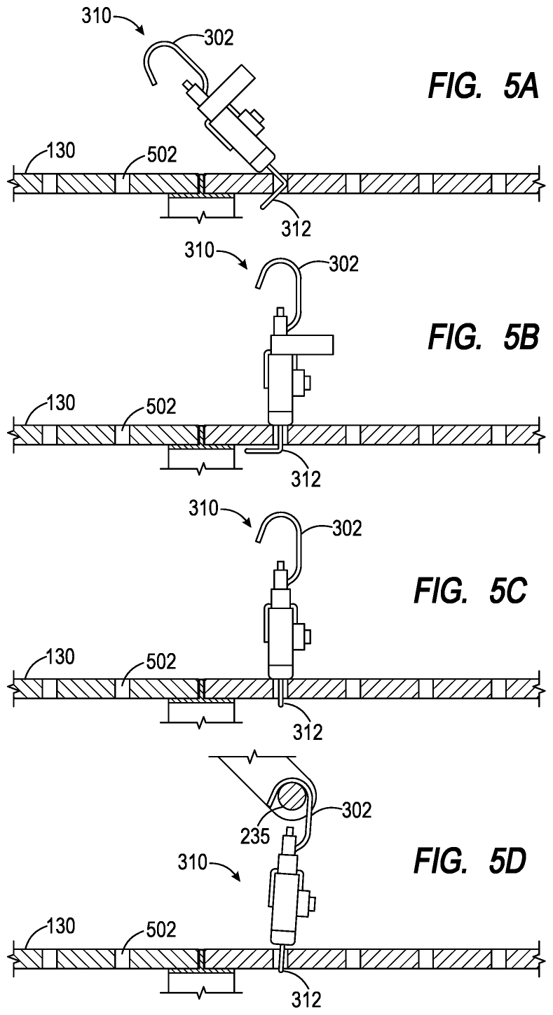

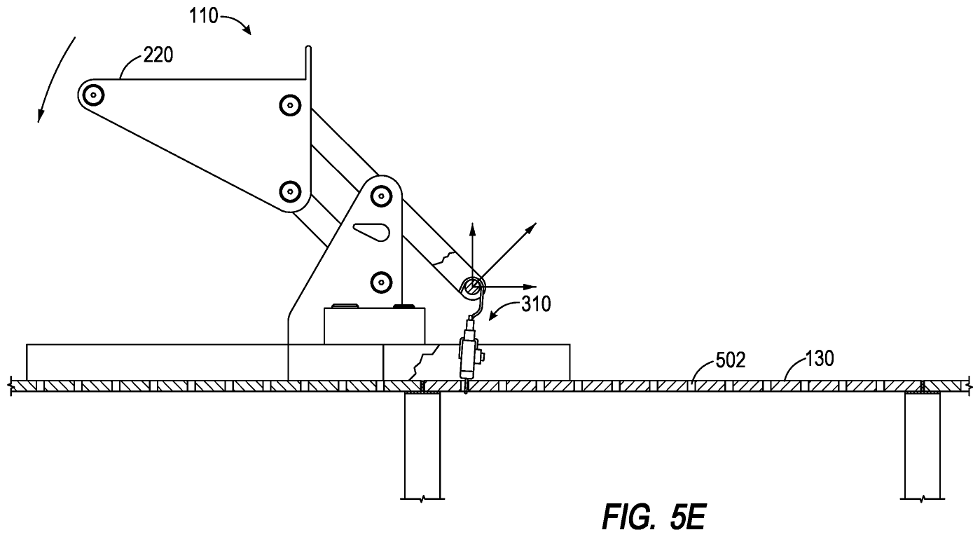

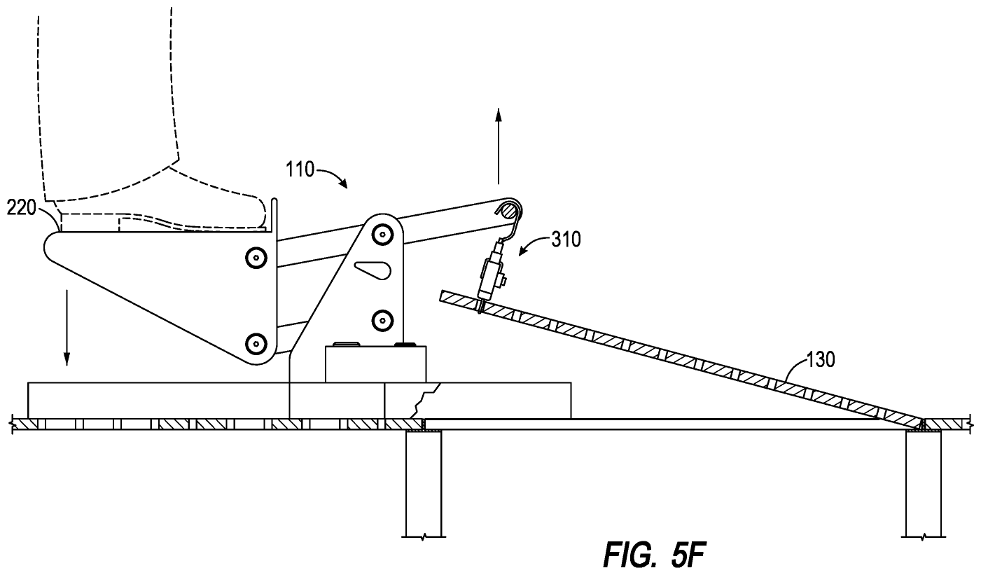

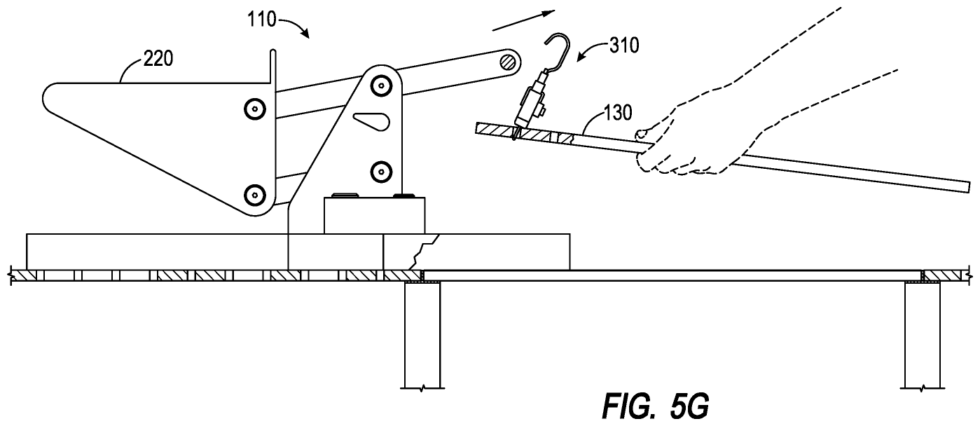

FIGS. 5A-5G illustrate an example sequence for operating a raised floor tile separating device 110 to separate a floor tile from an elevated floor surface, according to one embodiment. Note that while FIGS. 5A-5G depict a particular sequence using the raised floor tile separating device 110, in other embodiments, a different sequence with similar steps can be implemented using the raised floor tile separating device 110. Additionally, note that while FIGS. 5A-5G illustrate using the raised floor tile separating device 110 to separate a perforated floor tile, note that a similar sequence can be used to separate a non-perforated floor tile.

As shown in FIGS. 5A-5B, one or more hooks (e.g., hooks 308 and 312) of an attachment tool 310 are inserted into holes 502 of the perforated floor tile 130. As shown in FIG. 5C, the hooks of the attachment tool are adjusted to keep the attachment tool engaged to the perforated floor tile. As shown in FIGS. 5D-5E, the attachment tool is connected to the connector 235 of the raised floor tile separating device 110. As shown in FIG. 5F, as the user applies downward force to the pedal 220 of the raised floor tile separating device 110, the ratchet 255 turns and lifts the attachment tool 310. That is, via the raised floor tile separating device 110, the downward force applied to the pedal 220 results in an upward force being applied to the floor tile 130, successfully dislodging the floor tile 130 from the elevated floor surface. As shown in FIG. 5G, once the floor tile 130 is successfully dislodged, the user can disengage the attachment tool 310 and the floor tile 130 from the raised floor tile separating device 110. Note, in certain embodiments, the pedal 220 may remain in a fixed position after the user removes their foot from the pedal 220 (as shown in FIG. 5G), so that the user can remove the floor tile 130 from the raised floor tile separating device 110. That is, the pedal may not auto retract to the position shown in FIG. 5E after the user stops applying downward force to the pedal 220.

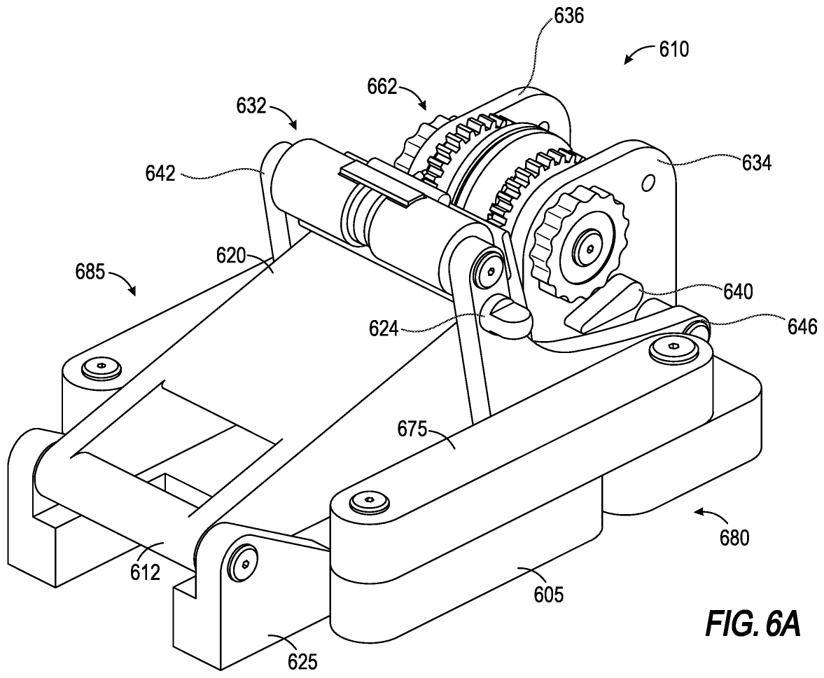

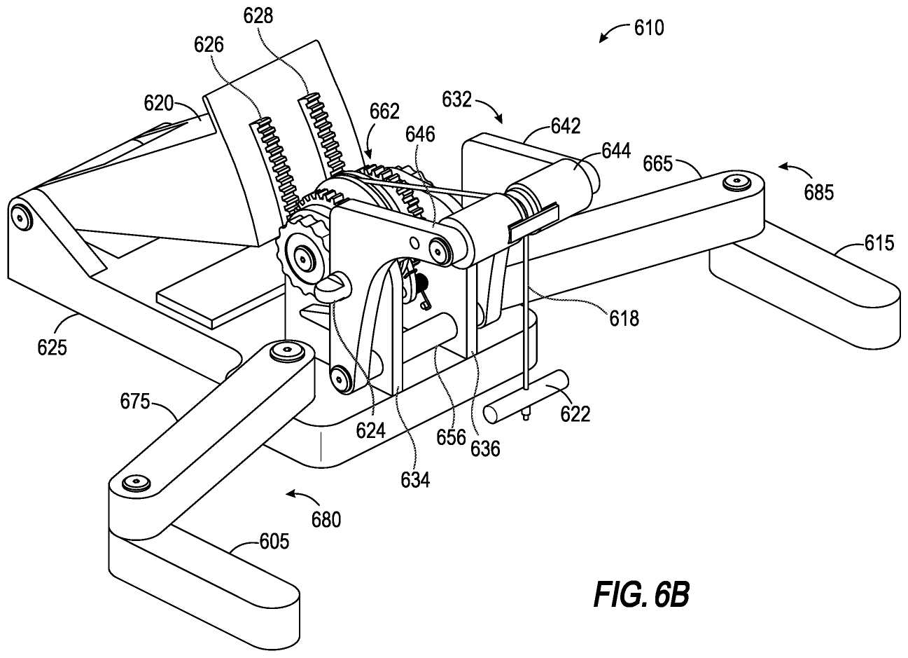

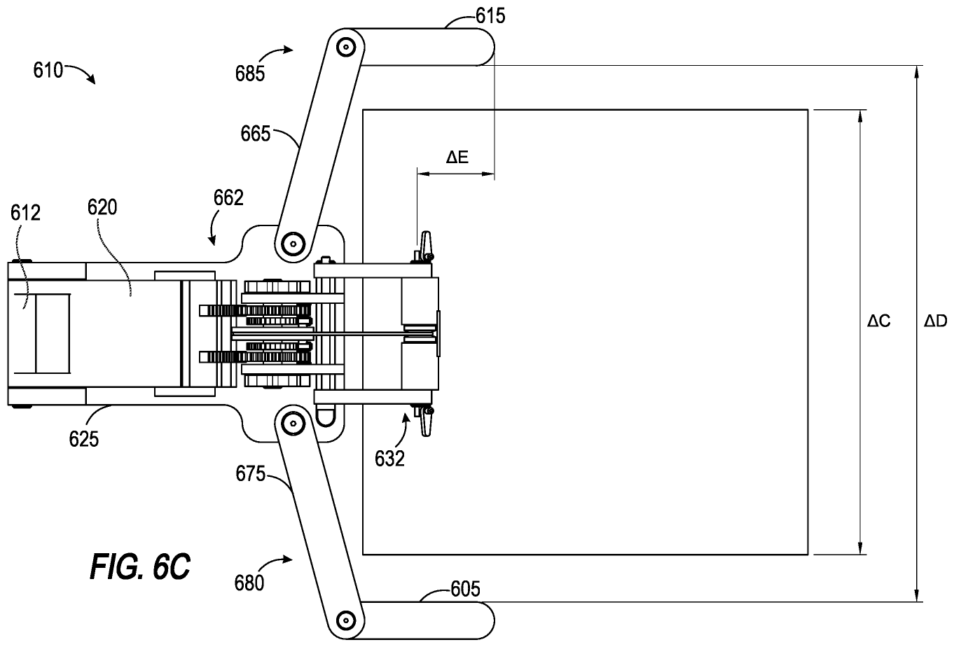

FIGS. 6A-6C illustrate different views of an example raised floor tile separating device 610, according to one embodiment. In particular, FIGS. 6A-6B are different perspective views of the raised floor tile separating device 610 and FIG. 6C is a top view of the raised floor tile separating device 610. As shown, the raised floor tile separating device 610 includes a frame, which includes a base 625, a side member 634 disposed on the base 625, and a side member 636 disposed on the base 625. The side member 634 is coupled to the side member 636 via at least a connector 656 (e.g., rod, pin, bar, etc.).

The raised floor tile separating device 610 also includes a pedal 620, which is disposed on the base 625. In certain embodiment, the pedal 620 can rotate about a connector 612 (e.g., rod, pin, bar, etc.). Additionally, in certain embodiments, the connector 612 may be used as a handle for carrying, transporting, and storing the raised floor tile separating device 610.

The raised floor tile separating device 610 also includes two matching side arms 680 and 685. The side arm 685 includes a member 665 and a member 615. The side arm 680 includes a member 675 and a member 605. The side arms 680 and 685 can be adjusted to allow for easy storage and transportation throughout an environment. For example, as shown in FIG. 6A, the raised floor tile separating device 610 may have a compact form factor when the member 665 and the member 615 of the side arm 685 are folded in, and the member 675 and the member 605 of the side arm 680 are folded in. Similarly, as shown in FIGS. 6B-6C, when the raised floor tile separating device 610 is used to dislodge a floor tile 130, the member 665 and the member 615 of the side arm 685 can be extended, and the member 675 and the member 605 of the side arm 680 can be extended, such that the member 615 is parallel to one side of the floor tile 130 and the member 605 is parallel to another side of the floor tile 130. As shown in FIG. 6C, when the raised floor tile separating device 610 is deployed around a floor tile 130, the distance between the side member 615 and the side member 605 is D inches, where D is greater than C (e.g., the length/width of the floor tile 130).

Additionally, in certain embodiments, the side arms 680 and 685 can be used as anchors to prevent the raised floor tile separating device 610 from sliding or moving as the floor tile 130 is being dislodged from the elevated floor surface. Additionally or alternatively, in certain embodiments, the base 625 can be anchored to the floor tile underneath the base 625 to prevent the raised floor tile separating device 110 from sliding or moving as the floor tile 130 is being dislodged from the elevated floor surface. Additionally or alternatively, in certain embodiments, the bottom surface of the base 625 may include a non-slip resistant surface to prevent the raised floor tile separating device 110 from sliding or moving as the floor tile 130 is being dislodged from the elevated floor surface.

The raised floor tile separating device 610 further includes a pulley mechanism 632, which includes a member 642, a member 646, and a connector 644, which couples the member 646 and the member 642. In certain embodiments, the pulley mechanism 632 can rotate about the connector 656 towards the pedal 620 to allow the raised floor tile separating device 610 to have a compact form factor (e.g., for easy transportation, storage, etc.), as shown in FIG. 6A. In certain embodiments, the pulley mechanism 632 can rotate about the connector 656 away from the pedal 620, when the raised floor tile separating device 610 is being used to dislodge a particular floor tile. When the pulley mechanism 632 is in a desired position, the knob 624 can be used to lock the pulley mechanism 632 in the desired position.

The raised floor tile separating device 610 includes ratchet apparatus 662, which includes one or more ratchets for driving a cable 618. The ratchet apparatus 662 is disposed between the side members 634 and 636, as shown in FIG. 6B. In certain embodiments, when a user applies pressure to the pedal 620, the notches 626 and 628 on the pedal 620 may cause the ratchet apparatus 662 to turn, which in turn, winds up the cable 618 and the connector 622. In such embodiments, the release button 640 can be used to reset the ratchet apparatus 662 (e.g., once travel of the pedal 620 is stopped). In certain embodiments, the connector 622 can be used to attach different types of attachment tools, such as the attachment tool 310, attachment tool 410, etc.

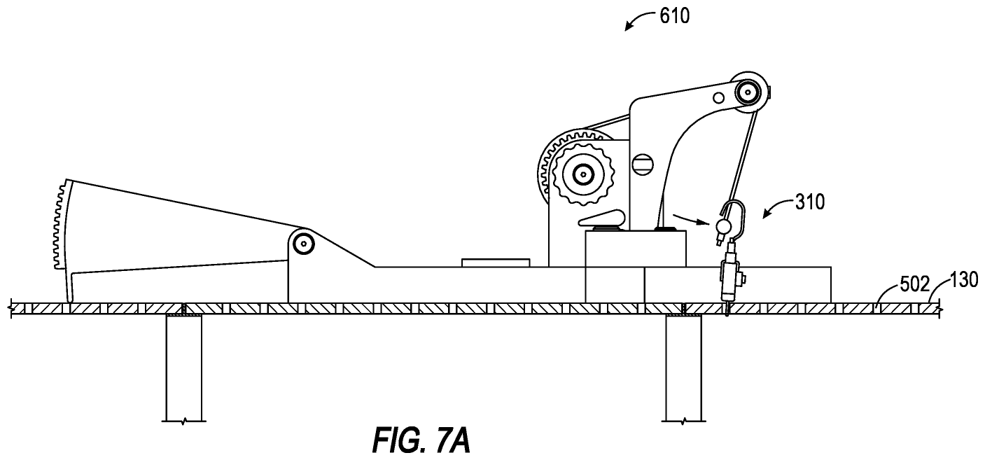

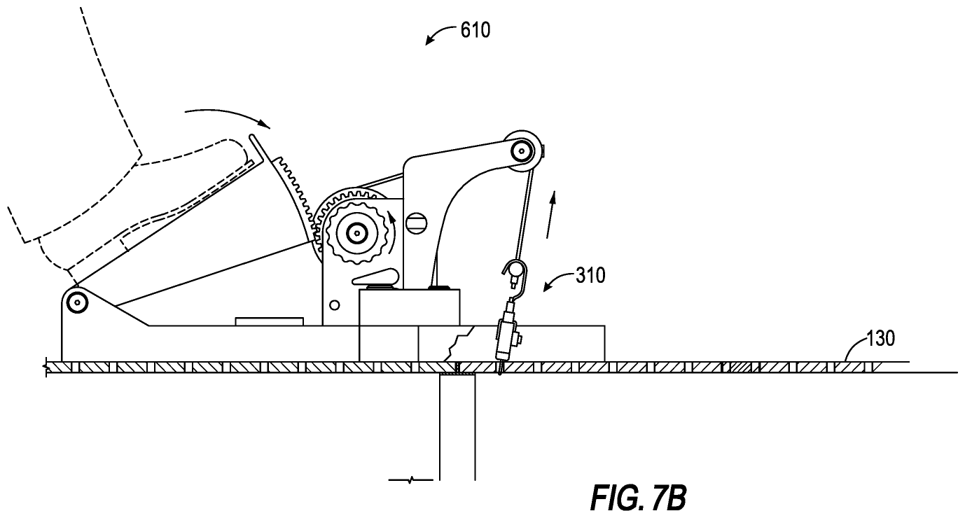

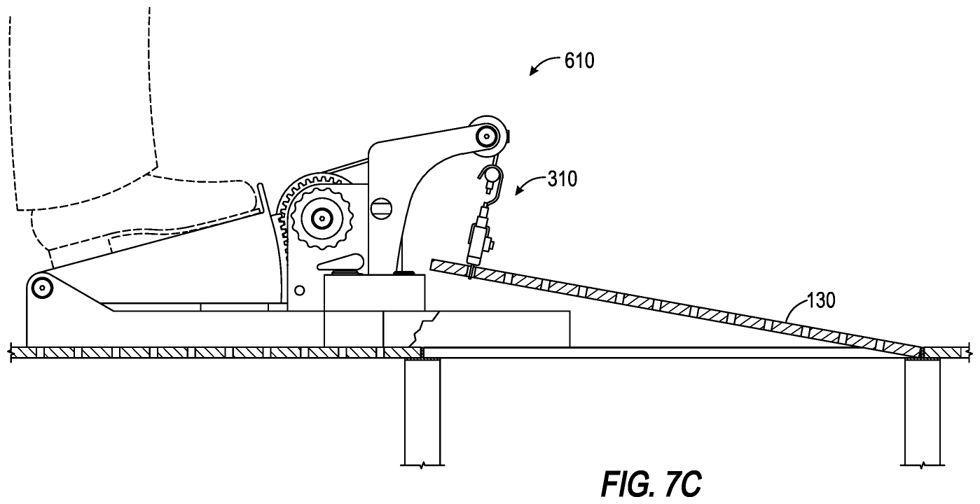

FIGS. 7A-7C illustrate an example sequence for operating a raised floor tile separating device 610 to separate a floor tile from an elevated floor surface, according to one embodiment. Note that while FIGS. 7A-7C depict a particular sequence using the raised floor tile separating device 610, in other embodiments, a different sequence with similar steps can be implemented using the raised floor tile separating device 610. Additionally, note that while FIGS. 7A-7C illustrate using the raised floor tile separating device 610 to separate a perforated floor tile, note that a similar sequence can be used to separate a non-perforated floor tile.

As shown in FIG. 7A, one or more hooks (e.g., hooks 308 and 312) of an attachment tool 310 are inserted into holes 502 of the perforated floor tile. The attachment tool 310 is then coupled to the raised floor tile separating device 610. As shown in FIG. 7B, as the user applies downward force to the pedal of the raised floor tile separating device 610, the ratchet turns and winds the cable, which lifts the attachment tool 310. That is, via the raised floor tile separating device 610, the downward force applied to the pedal results in an upward force being applied to the floor tile 130, successfully dislodging the floor tile 130 from the elevated floor surface. As shown in FIG. 7C, once the floor tile 130 is successfully dislodged, the user can disengage the attachment tool 310 and the floor tile 130 from the raised floor tile separating device 610. Note, in certain embodiments, when the user applies downward force to the pedal of the raised floor tile separating device 610, the pedal may spring return to an initial starting position (e.g., FIG. 7B) once the pedal is fully depressed (e.g., as shown in FIG. 7C).

Aspects of the present invention may take the form of an entirely hardware embodiment that may be generally referred to herein as a “module,” “apparatus,” or “system.” The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing is directed to embodiments of the present invention, other and further embodiments of the invention may be devised without departing from the basic scope thereof, and the scope thereof is determined by the claims that follow.

What is claimed is:

1. A raised floor tile separating apparatus comprising:
a frame having a bottom member, a first side member disposed on the bottom member, and a second side member disposed on the bottom member, the first side member being parallel to the second side member;
a pedal disposed between the first side member and the second side member; and
a pivot arm coupled to and disposed between the first side member and the second side member, wherein a first end of the pivot arm is coupled to the pedal and a second end of the pivot arm is coupled to a tile attachment tool.

2. The raised floor tile separating apparatus of claim 1, wherein the tile attachment tool is configured to attach to a perforated floor tile of an elevated floor surface.

3. The raised floor tile separating apparatus of claim 2, wherein the tile attachment tool is a hook attachment tool comprising one or more hooks for attaching to one or more holes of the perforated floor tile.

4. The raised floor tile separating apparatus of claim 1, wherein the tile attachment tool is configured to attach to a non-perforated floor tile of an elevated floor surface.

5. The raised floor tile separating apparatus of claim 4, wherein the tile attachment tool is a suction cup attachment tool comprising one or more suction cups for attaching to the non-perforated floor tile.

6. The raised floor tile separating apparatus of claim 1, wherein:
the raised floor tile separating apparatus is disposed on a first floor tile of an elevated floor surface; and
the tile attachment tool is connected to a second floor tile of the elevated floor surface that is adjacent to the first floor tile.

7. The raised floor tile separating apparatus of claim 1, further comprising a ratchet coupled to the first side member, the second side member and the pivot arm, wherein the raised floor tile separating apparatus is configured to transfer, via the ratchet and pivot arm, a directional force applied to the pedal to a floor tile as a lifting force, such that the floor tile is dislodged from an elevated floor surface.

8. The raised floor tile separating apparatus of claim 1, wherein the pedal further comprises a handle member.

9. A raised floor tile separating apparatus comprising:
a bottom member;
a ratchet disposed above the bottom member;
a pedal at an inclination with respect to the bottom member;
a pulley coupled to the bottom member; and
a cable having at least a first end coupled to the ratchet and a second end coupled to a tile attachment tool, the cable extending from the first end to the second end through the pulley.

10. The raised floor tile separating apparatus of claim 9, wherein the tile attachment tool is configured to attach to a perforated floor tile of an elevated floor surface.

11. The raised floor tile separating apparatus of claim 10, wherein the tile attachment tool is a hook attachment tool comprising one or more hooks for attaching to one or more holes of the perforated floor tile.

12. The raised floor tile separating apparatus of claim 9, wherein the tile attachment tool is configured to attach to a non-perforated floor tile of an elevated floor surface.

13. The raised floor tile separating apparatus of claim 12, wherein the tile attachment tool is a suction cup attachment tool comprising one or more suction cups for attaching to the non-perforated floor tile.

14. The raised floor tile separating apparatus of claim 9, wherein:
the pedal comprises one or more notches disposed on a side of the pedal; and
the pedal is configured to turn the ratchet via the one or more notches when a directional force is applied to the pedal.

15. The raised floor tile separating apparatus of claim 14, wherein the ratchet is configured to wind the cable when a downward force is applied to the pedal.

16. The raised floor tile separating apparatus of claim 15, wherein the ratchet is configured to wind the cable, such that the directional force is transferred to a floor tile as a lifting force.

17. The raised floor tile separating apparatus of claim 9, wherein the ratchet comprises a button that releases tension of the cable when the button is engaged.

18. A system comprising:
an elevated floor surface comprising a plurality of floor tiles;
an access area disposed beneath the elevated floor surface; and
the raised floor tile separating apparatus of one of claim 1 and claim 9, the raised floor tile separating apparatus being disposed on a first floor tile of the plurality of floor tiles and having the tile attachment tool attached to an adjacent second floor tile of the plurality of floor tiles.

19. The system of claim 18, wherein the tile attachment tool is a hook attachment tool.

20. The system of claim 18, wherein the tile attachment tool is a suction cup attachment tool.
